(19) United States
(12) Patent Application Publication
(10) Pub. No.: US 2023/0395851 A1
(43) Pub. Date: Dec. 7, 2023

(54) UNSATURATED ADDITIVE FOR LITHIUM ION BATTERY

(71) Applicant: NOHMS Technologies, Inc., Rochester, NY (US)

(72) Inventors: Surya S. Moganty, Henrietta, NY (US); Rutvik Vaidya, Rochester, NY (US); Gabriel Torres, Rochester, NY (US); John Sinicropi, Rochester, NY (US); Yue Wu, West Henrietta, NY (US); Kevin Brown, Jr., Rochester, NY (US)

(21) Appl. No.: 18/028,373

(22) PCT Filed: Mar. 11, 2021
(86) PCT No.: PCT/US2021/021832

§ 371 Date: Mar. 24, 2023

Related U.S. Application Data
(60) Provisional application No. 63/063,656, filed on Aug. 10, 2020.

(51) Int. Cl. H01M 10/0567; H01M 10/0569; H01M 10/0568; H01M 10/0525; C07F 9/173

(52) U.S. Cl. CPC H01M 10/0567; H01M 10/0569; H01M 10/0568; H01M 10/0525; C07F 9/173; H01M 2300/004

(57) ABSTRACT

The present disclosure relates to a phosphorus additive that is useful for stable cycling and storage of lithium ion cells at high temperatures, an electrolyte containing the phosphorus additive, and an electrochemical energy storage device containing the electrolyte. An electrolyte includes an aprotic organic solvent system; a metal salt; and at least one thiophosphate additive having an unsaturated terminal group, according to the formula:

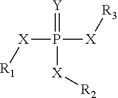

### CROSS REFERENCE

This application claims the benefit of the filing date of U.S. Provisional Patent Application No. 63/063,656 filed Aug. 10, 2020, which is hereby incorporated by reference in its entirety.

### FIELD

The present disclosure relates to a thio-phosphorus additive that is useful for stable cycling and storage of lithium ion cells at high temperatures, an electrolyte containing the thio-phosphorus additive, and an electrochemical energy storage device containing the electrolyte.

### BACKGROUND

Li-ion batteries are heavily used in consumer electronics, electric vehicles (EVs), as well as energy storage systems (ESS) and smart grids. Recently, Li-ion batteries with voltages above 4.2 V have gained importance because of higher capacity and subsequently energy density benefits. However, the stability of the cathode materials at these potentials reduces due to increased electrolyte oxidation. This may result in electrochemical oxidation of the material to produce gases, and that can deteriorate the performance of the battery. The cathode active material, which is capable of intercalating/deintercalating lithium ions may dissolve in the non-aqueous electrolyte, resulting in a structural breakdown of the cathode, and will lead to an increase in the interfacial resistance. These Li-ion batteries are also typically exposed to extreme temperatures during their operation. The SEI (Solid Electrolyte Interface) layer formed on the anode is gradually broken down at high temperatures, and hence leads to more irreversible reaction resulting in capacity loss. These reactions happen on the positive and negative electrode during cycling but are generally more severe at higher temperatures due to faster kinetics. The next generation Li-ion batteries used in consumer electronics, EVs, and ESS will require significant improvements in the electrolyte component relative to the current state-of-the art of Li-ion batteries.

The shuttling of positive and negative ions between the battery electrodes is the main function of the electrolyte. Historically, researchers have focused on developing battery electrodes, and electrolyte development has been limited. Traditional Li-ion batteries used carbonate-based electrolytes with a large electrochemical window, that can transport lithium ions. These electrolytes need functional additives to passivate the anode and form a stable SEI layer. At the same time, there is a need to design and develop additives that allow stable and safe cycling of high voltage Li-ion batteries at high temperatures.

As the industry moves towards higher energy cathode materials for higher energy batteries, stable, efficient, and safe cycling of batteries in wide voltage windows is necessary. Li-ion battery electrolytes can be tuned based on their applications by addition of different co-solvents and additives. This tunability has enabled the development of different additives for high voltage stability and safety of Li-ion cells. Another aspect of high-voltage Li-ion battery electrolyte development is design and optimization of additives for stable cycling at elevated temperatures, as batteries today have a variety of applications where the cell is exposed to different temperature and pressure conditions. Anode SEI forming additives are extensively studied, but interaction and benefits of using different cathode additives is reported less frequently but can lead to significant changes in the battery performance.

Battery cathode material development has enabled batteries that can be charged up to high voltages. The energy density of batteries can be significantly increased by charging them to higher voltages, thus enabling longer battery life per a single charge. In practice, this can result in longer driving ranges for EVs and more battery life for electronic devices and reduces the size and weight of battery packs used in ESS. To keep up with this development, battery electrolytes need functional additives to extend the voltage stability of conventional liquid electrolytes. Li-ion batteries with high voltage cathodes stored at high temperatures, especially at 100% SOC, have heavy gas generation due to electrolyte decomposition. This is a result of electrolyte components reacting with the electrode materials, and heavy gas generation is a serious safety risk when storing lithium ion batteries. Hence, there is a need to develop and optimize electrolyte formulations that can reduce the gas generation, and hence improve the high temperature storage characteristics of lithium ion batteries. To achieve this, there is a need to design and develop additives that allow stable and safe cycling and storage of high voltage Li-ion batteries at high temperatures.

U.S. Pat. No. 10,497,975 B2 and U.S. Patent Application Nos. 20180076483 A1 and 20190089000 A1 by Shenzhen Capchem demonstrate the use of propargyl phosphate esters in lithium ion battery electrolytes. They claim to improve the high temperature cycling performance and low temperature rate performance. However, thio-phosphates are not considered as electrolyte additives in the prior art.

### SUMMARY

In accordance with one aspect of the present disclosure, there is provided an electrolyte for an electrochemical energy storage device, the electrolyte includes: a thiophosphate additive, such as a thiophosphate ester additive, with an unsaturated terminal group; an aprotic organic solvent system; a metal salt; and at least one additional additive.

In accordance with another aspect of the present disclosure, there is provided an electrolyte for an electrochemical energy storage device, the electrolyte includes: a thiophosphate ester additive with an unsaturated terminal group; an aprotic organic solvent system; a metal salt; and at least one additional additive; wherein the thiophosphate ester additive with an unsaturated terminal group has at least one phosphorous moiety and one sulfur moiety.

In accordance with another aspect of the present disclosure, there is provided an electrolyte for an electrochemical energy storage device, the electrolyte includes: a thiophosphate ester additive with an unsaturated terminal group; an aprotic organic solvent system; a metal salt; and at least one additional additive; wherein the aprotic organic solvent includes an open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

In accordance with another aspect of the present disclosure, there is provided an electrolyte for an electrochemical energy storage device, the electrolyte includes: a thiophosphate ester additive with an unsaturated terminal group; an aprotic organic solvent system; a metal salt; and at least one additional additive; wherein the cation of the metal salt contains lithium, sodium, aluminum or magnesium.

In accordance with another aspect of the present disclosure, there is provided an electrochemical energy storage device electrolyte including:
a) an aprotic organic solvent system;
b) a metal salt; and
c) at least one thiophosphate additive having an unsaturated terminal group, according to the formula:

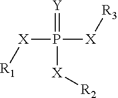

wherein:
Y is oxygen or sulfur;
X is independently oxygen or sulfur, with the proviso that if Y is oxygen then least one X is sulfur;
R₃ is selected from hydrocarbyl group having 1 to 10 carbon atoms with an unsaturated terminal group;
R₁ and R₂ is R₃; or
R₁and R₂ are independently C₁-C₁₀ substituted or unsubstituted alkyl groups, or aryl groups; wherein the hydrogen atoms can be unsubstituted or can be a halogen, alkyl, alkoxy, perfluorinated alkyl, silyl, siloxy, silane, sulfoxide, amide, azo, ether, and thioether group or combinations thereof.

In accordance with another aspect of the present disclosure, there is provided an electrochemical energy storage device including: a cathode; an anode; an electrolyte according to the present disclosure; and a separator.

In accordance with another aspect of the present disclosure, there is provided an electrolyte for an electrochemical energy storage device, the electrolyte includes: a thiophosphate ester additive with an unsaturated terminal group; an aprotic organic solvent system; a metal salt; and at least one additional additive; wherein the additional additive contains compounds containing at least one unsaturated carbon-carbon bond, carboxylic acid anhydrides, sulfur-containing compounds, phosphorus-containing compounds, boron-containing compounds, silicon-containing compounds or mixtures thereof.

### BRIEF DESCRIPTION OF DRAWINGS

FIG. 1 shows the dQ/dV profiles of electrolytes tested in NMC811/Si—Gr cells;

FIG. 2 shows the dQ/dV profiles of electrolytes tested in NMC811/Gr cells; and

FIG. 3 shows the cycle life characteristics of cells during cycling for charging and discharging.

### DETAILED DESCRIPTION

The disclosed technology relates generally to lithium-ion (Li-ion) battery electrolytes. In an embodiment, the disclosure is directed towards a thiophosphate additive with an unsaturated terminal group, electrolytes containing the additive materials, and electrochemical energy storage devices containing the electrolytes.

The present disclosure describes a Li-ion battery electrolyte with an electrolyte additive that can overcome high temperature stability challenges in Li-ion batteries, particularly those operated at high-voltages. Current state-of-the-art Li-ion battery electrolytes are tuned towards room temperature application, and researchers have recently started focusing on the safety of the battery by using safe co-solvents and additives. There is a need to develop an electrolyte solution for cycling of Li-ion cells with high voltage cathodes at elevated temperatures. The proposed technology is based on an innovative electrolyte additive containing an unsaturated terminal group on a phosphorus group, such as a thiophosphate ester functional group, that can improve the stability of high-voltage cathode during high-temperature operation. The electrolyte additives form a unique electrode electrolyte interface (EEI), but do not excessively passivate the anode, when used at low weight loadings.

In an embodiment, thiophosphate ester compounds with unsaturated terminal groups are disclosed as electrolyte additives according to the present disclosure. These thiophosphate ester additives with an unsaturated terminal group have high solubility in organic solvents. The electrolytes with these additives have high ionic conductivity and are suitable for use as electrolytes for electrochemical devices, particularly Li-ion batteries. Suitable amounts of additives in accordance with the present disclosure include from 0.001% to 25% by weight to impart the necessary properties to the electrolyte, thus enhancing the performance of electrochemical devices, particularly lithium ion batteries.

Unsaturated terminal groups like allyl, propargyl, and vinyl groups help with polymerization of the electrode surface, thus increasing the resistance. This forms a film or a network on the electrode surface, and hence long-term performance improves. The film prevents the electrolyte-electrode reaction, which results in lower gas generation during high temperature storage and cycling operations. Compounds with all three terminal unsaturated groups have very high resistance, and hence alkoxy or aryloxy substituents are added. These alkoxy or aryloxy groups in addition to allyl, propargyl, vinyl, styrenic and acrylic terminal groups help optimize the resistance, while maintaining long-term performance.

In an embodiment, an electrochemical energy storage device electrolyte includes a) an aprotic organic solvent system; b) a metal salt; c) a thiophosphate additive with an unsaturated terminal group and d) at least one additional additive.

In an embodiment of the disclosure, suitable molecular structures of the thiophosphate additive with an unsaturated terminal group are depicted below:

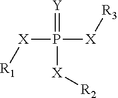

wherein:
Y is oxygen or sulfur;
X is independently oxygen or sulfur, with the proviso that if Y is oxygen then least one X is sulfur;
R₃ is selected from hydrocarbyl group having 1 to 10 carbon atoms with an unsaturated terminal group;
R₁ and R₂ is R₃; or
R₁ and R₂ are independently C₁-C₁₀ substituted or unsubstituted alkyl groups, or aryl groups; wherein the hydrogen atoms can be unsubstituted or can be a halogen, alkyl, alkoxy, perfluorinated alkyl, silyl, siloxy, silane, sulfoxide, amide, azo, ether, and thioether group or combinations thereof.

The unsaturated terminal group can be selected from a group consisting of alkenyl and alkynyl groups such as allyl, propargyl, and vinyl groups; styrenic, and acrylic groups, or combinations thereof.

In another embodiment, a electrolyte is provided that includes an additive with an unsaturated terminal group, wherein the unsaturated terminal group is a pendant group attached to a backbone, wherein the backbone is at least one of thiophosphate ester compound, a triazene molecule, a phosphazene molecule and an ionic liquid with cationic moieties selected from a nitrogen cation moiety, a phosphorous cation moiety, and a sulfur cation moiety.

In another embodiment, the unsaturated terminal group is attached to a backbone selected from at least one of thiophosphate ester, triazene, phosphazene, and an ionic liquid with cationic moieties selected from a nitrogen cation moiety, a phosphorous cation moiety, and a sulfur cation moiety.

In another embodiment, the anion of an ionic liquid in accordance with the present disclosure includes but is not limited to halides (e.g., Cl, Br), nitrates (e.g., NO₃), phosphates (e.g., PF₆, TFOP), imides (e.g. TFSI, BETI), borates (e.g., BOB, BF₄), aluminates, arsenides, cyanides, thiocyanates, nitrites, benzoates, carbonates, chlorates, chlorites, chromates, sulfates, sulfites, silicates, thiosulfates, or hydroxides.

In another embodiment, the thiophosphate ester additive with an unsaturated terminal group is present in the electrolyte in a range of from 0.001% to 25% by weight.

The disclosure includes a method for synthesizing the thiophosphate ester additives with an unsaturated terminal group, and the use of such molecules in lithium ion battery electrolytes. These molecules impart greater stability to the electrolytes at higher operating temperatures.

In an embodiment of the disclosure, the electrolyte further includes a lithium salt in a range of from 10% to 30% by weight. A variety of lithium salts may be used, including, for example, Li(AsF₆); Li(PF ₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PP₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{1o-j′}H_{j′}]; or a mixture of any two or more thereof, wherein Z is independent at each occurrence a halogen, j is an integer from 0 to 12 and j′ is an integer from 1 to 10.

In an embodiment of the disclosure, the electrolyte further includes an aprotic organic solvent selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof in a range of from 60% to 90% by weight.

Examples of aprotic solvents for generating electrolytes include but are not limited to dimethyl carbonate, ethyl methyl carbonate, diethyl carbonate, methyl propyl carbonate, ethyl propyl carbonate, dipropyl carbonate, propylene carbonate, ethylene carbonate, fluoroethylene carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, ethyl propionate, butyl propionate, dimethoxyethane, triglyme, dimethylvinylene carbonate, tetraethyleneglycol, dimethyl ether, polyethylene glycols, triphenyl phosphate, tributyl phosphate, hexafluorocyclotriphosphazene, 2-Ethoxy-2,4,4,6,6-pentafluoro-1,3,5,2-5,4-5,6-5 triazatriphosphinine, triphenyl phosphite, sulfolane, dimethyl sulfoxide, ethyl methyl sulfone, ethylvinyl sulfone, allyl methyl sulfone, divinyl sulfone, fluorophenylmethyl sulfone and gamma-butyrolactone.

In an embodiment of the disclosure, the electrolytes further include at least one additional additive to protect the electrodes and electrolyte from degradation. Thus, electrolytes of the present technology may include an additive that is reduced or polymerized on the surface of an electrode to form a passivation film on the surface of the electrode. In some embodiments, electrolytes of the present technology further include mixtures of the two types of additives.

In an embodiment, an additive is a substituted or unsubstituted linear, branched, or cyclic hydrocarbon including at least one oxygen atom and at least one aryl, alkenyl or alkynyl group. The passivating film formed from such additives may also be formed from a substituted aryl compound or a substituted or unsubstituted heteroaryl compound where the additive includes at least one oxygen atom.

Representative additives include glyoxal bis(diallyl acetal), tetra(ethylene glycol) divinyl ether, 1,3,5-triallyl-1,3,5-triazine-2,4,6(1H,3H,5H)-trione, 1,3,5,7-tetravinyl-1,3,5,7-tetramethylcyclotetrasiloxane, 2,4,6-triallyloxy-1,3,5-triazine, 1,3,5-triacryloylhexahydro-1,3,5-triazine, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2-amino-3-vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2-vinyloxetane, 2-vinyloxy-cyclopropanone, 3-(N-vinylamino)cyclohexanone, 3,5-divinyl furoate, 3-vinylazetidin-2-one, 3 vinylaziridin-2-one, 3-vinylcyclobutanone, 3-vinylcyclopentanone, 3-vinyloxaziridine, 3-vinyloxetane, 3-vinylpyrrolidin-2-one, 2-vinyl-1,3-dioxolane, acrolein diethyl acetal, acrolein dimethyl acetal, 4,4-divinyl-3-dioxolan-2-one, 4-vinyltetrahydropyran, 5-vinylpiperidin-3-one, allylglycidyl ether, butadiene monoxide, butyl-vinyl-ether, dihydropyran-3-one, divinyl butyl carbonate, divinyl carbonate, divinyl crotonate, divinyl ether, divinyl ethylene carbonate, divinyl ethylene silicate, 1,3 propane sultone, 1,3 propene sultone, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, 4-fluoro-1,3-dioxolan-2-one, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone or a mixture of any two or more thereof. In some embodiments, the additive may be a cyclotriphosphazene that is substituted with F, alkyloxy, alkenyloxy, aryloxy, methoxy, allyloxy groups or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)cyclotriphosphazene or (diaryloxy)(trifluoro)(methoxy)cyclotriphosphazene compounds or a mixture of two or more such compounds.

In some embodiments the additive is a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof. In some embodiments, the additive is vinyl carbonate, vinyl ethylene carbonate, or a mixture of any two or more such compounds. Further, the additive is present in a range of from 0.01% to 10% by weight.

In some embodiments the additive is a fully or partially halogenated phosphoric acid ester compound, an ionic liquid, or mixtures thereof. The halogenated phosphoric acid ester may include 4-fluorophenyldiphenylphosphate, 3,5-difluorophenyldiphenylphosphate, 4-chlorophenyldiphenylphosphate, trifluorophenylphosphate, heptafluorobutyldiphenylphosphate, trifluoroethyldiphenylphosphate, bis(trifluoroethyl)phenylphosphate, and phenylbis(trifluoroethyl)phosphate. The ionic liquids may include tris(N-ethyl-N-methylpyrrolidinium)thiophosphate bis(trifluoromethylsulfonyl)imide, tris(N-ethyl-N-methylpyrrolidinium) phosphate bis(trifluoromethylsulfonyl)imide, tris(N-ethyl-N-methylpiperidinium)thiophosphate bis(trifluoromethylsulfonyl)imide, tris(N-ethyl-N-methylpiperidinium)phosphate bis(trifluoromethylsulfonyl)imide, N-methyl-trimethyl silylpyrrolidinium bis(trifluoromethylsulfonyl)imide, N-methyl-trimethylsilylpyrrolidinium hexafluorophosphate. Further, the additive is present in a range of from 0.01% to 10% by weight.

In another embodiment of the disclosure, an electrochemical energy storage device is provided that includes a cathode, an anode and an electrolyte including an ionic liquid as described herein. In one embodiment, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery. In some embodiments, the electrochemical energy storage device is a solar cell.

In an embodiment, a secondary battery is provided including a positive and a negative electrode separated from each other using a porous separator and the electrolyte described herein.

Suitable cathodes include those such as, but not limited to, a lithium metal oxide, spinel, olivine, carbon-coated olivine cathodes such as LiFePO₄, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCO_{y}Met_{z}O₂, A_{n′}B₂(XO₄)₃ (NASICON), vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, and 0≤z≤0.5 and 0≤n¹≤0.3. According to some embodiments, the spinel is a spinel manganese oxide with the formula of Liᵢ₊ₓMn_{2-z}Met′″_{y}O₄₋ₘX′ₙ, wherein Met″′ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of Li₁₊ₓFe_{1z}Met″_{y}PO₄₋ₘX′ₙ, wherein Met″ is Al, Mg, Ti, B, Ga, Si, Ni, Mn or Co; X′ is S or F; and wherein 0≤x≤0.3, 0 0≤y≤0.5, 0≤z≤0.5, 0≤m≤0.5 and 0≤n≤0.5.

Suitable anodes include those such as lithium metal, graphitic materials, amorphous carbon, carbon nanotubes, Li₄Ti₅O₁₂, tin alloys, silicon, silicon alloys, intermetallic compounds, or mixtures of any two or more such materials. Suitable graphitic materials include natural graphite, artificial graphite, graphitized meso-carbon microbeads (MCMB) and graphite fibers, as well as any amorphous carbon materials. In some embodiments, the anode and cathode electrodes are separated from each other by a porous separator.

The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

The following molecular structures are examples of suitable thiophosphate ester compounds with unsaturated terminal groups:

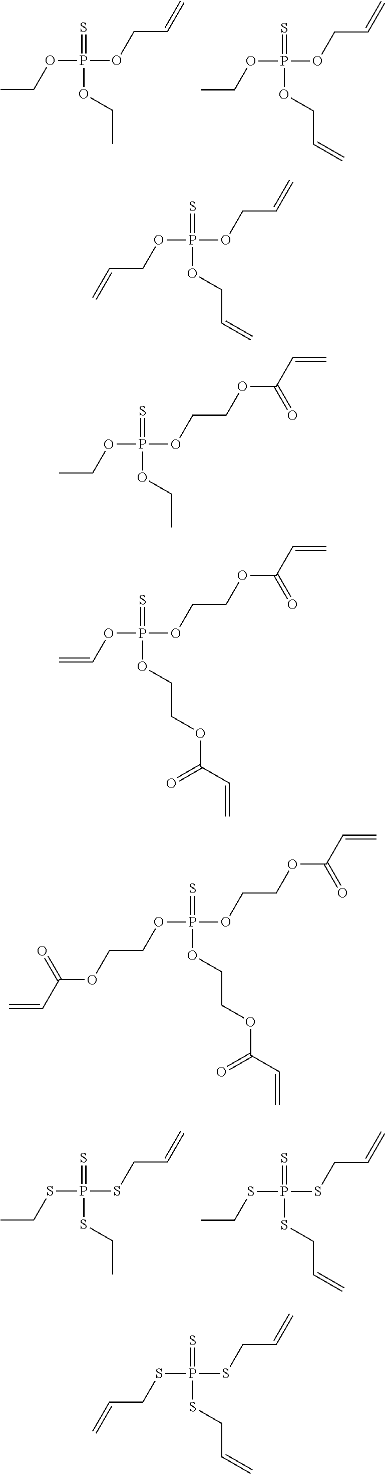

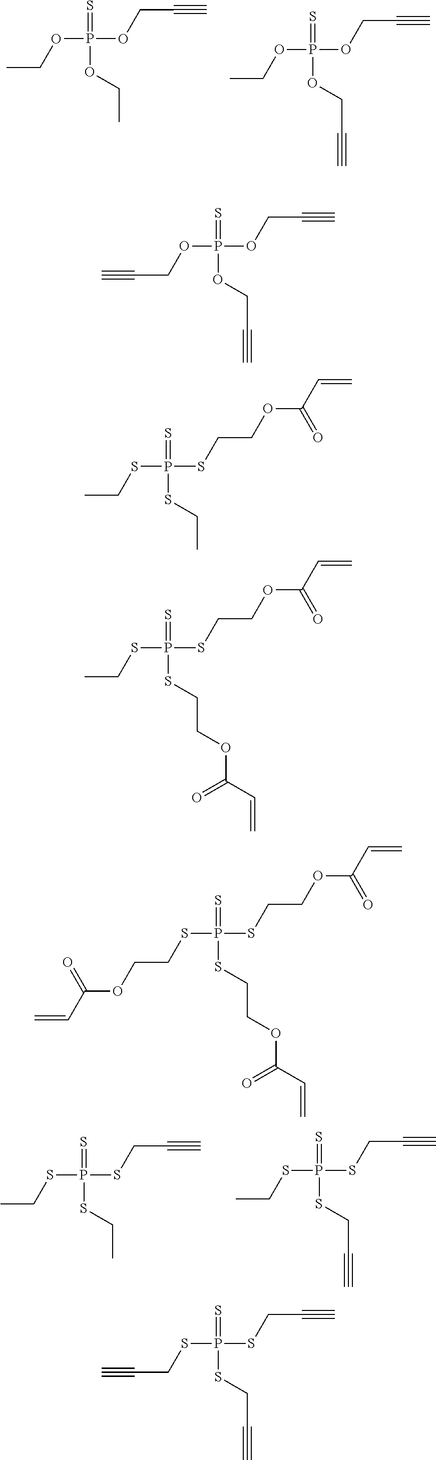

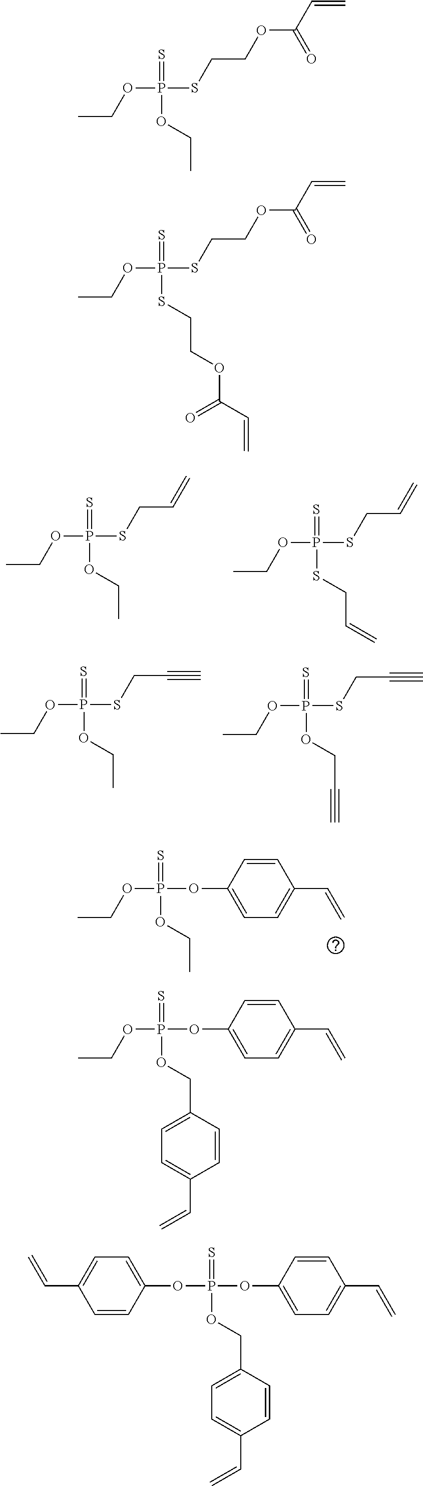

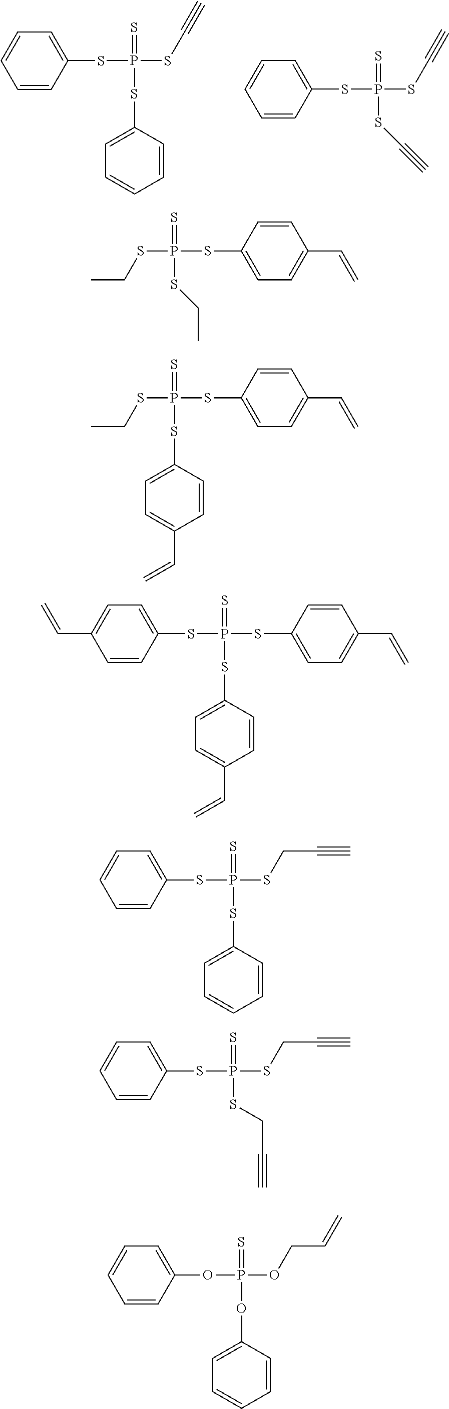

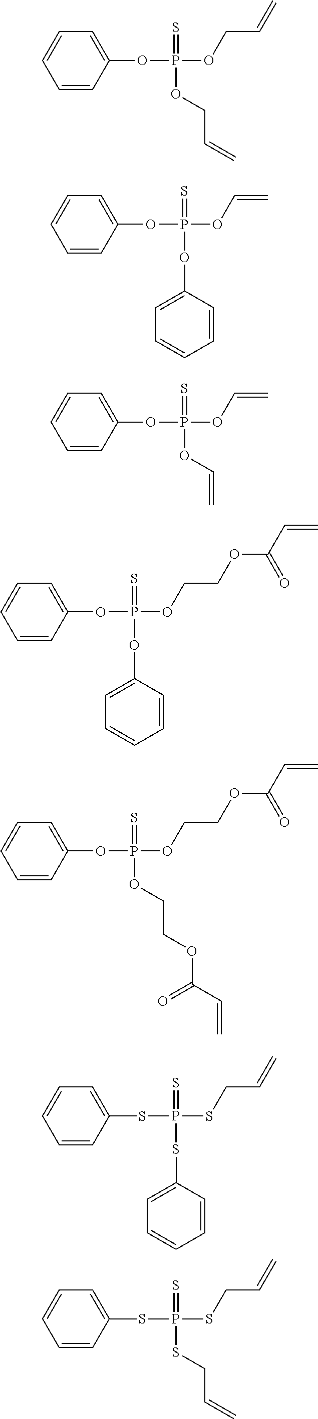

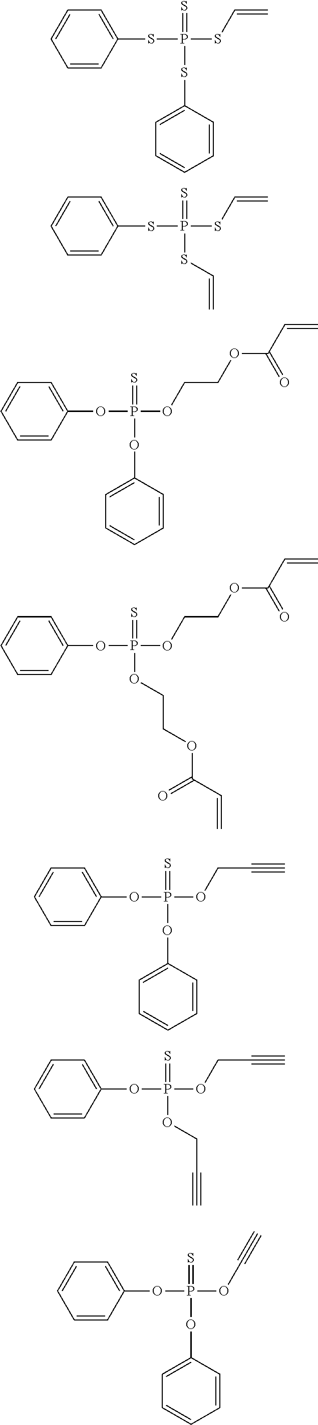

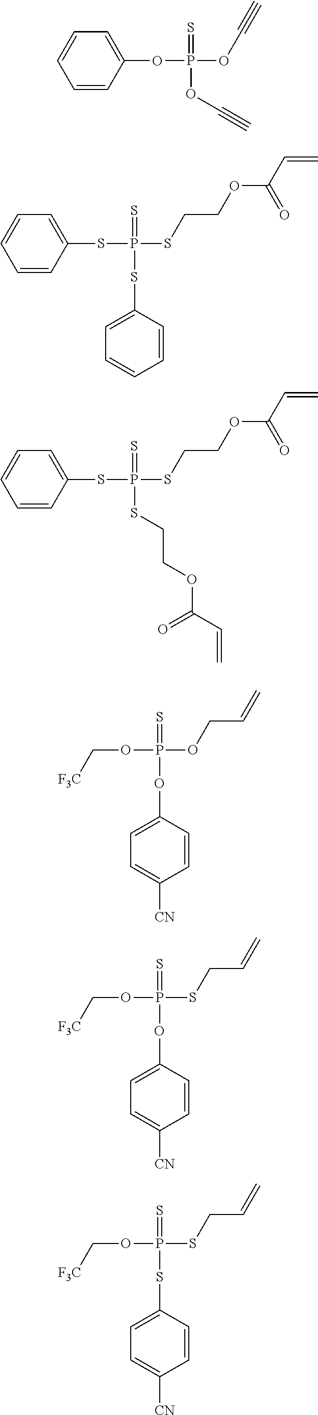

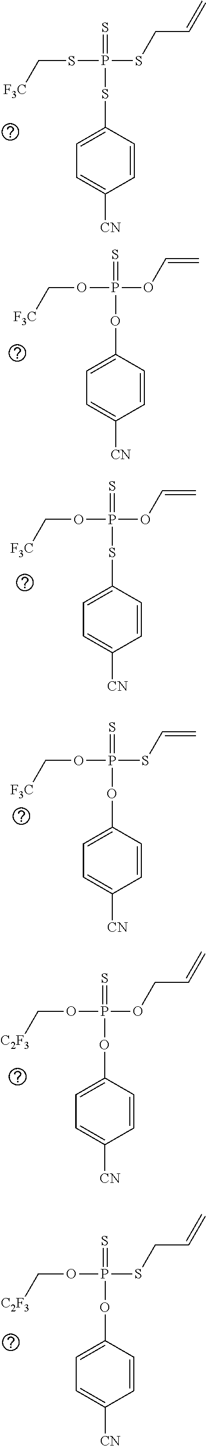

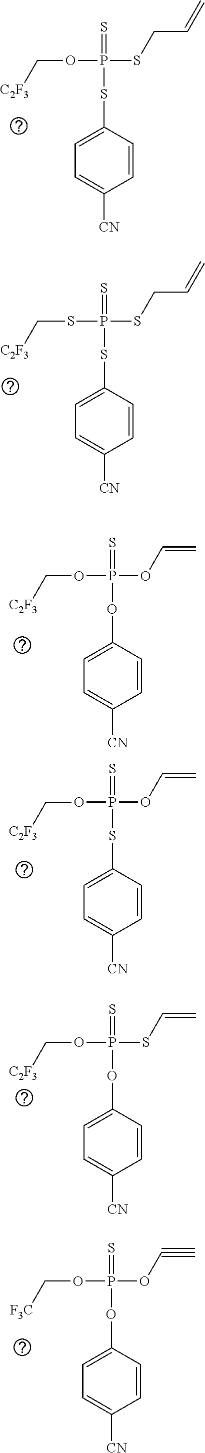

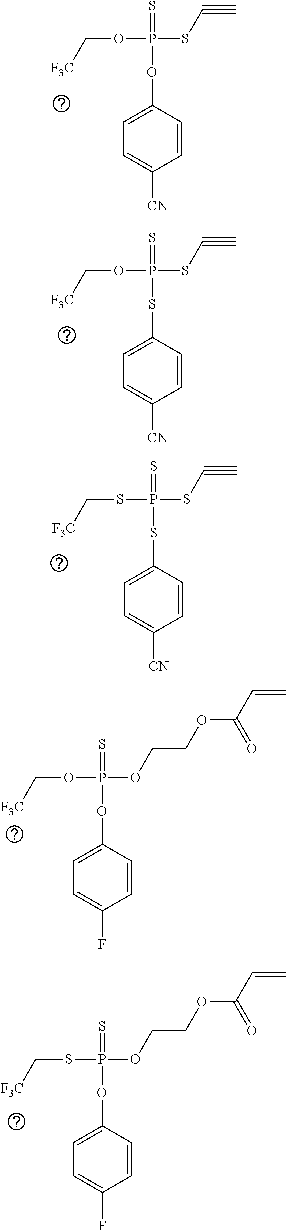

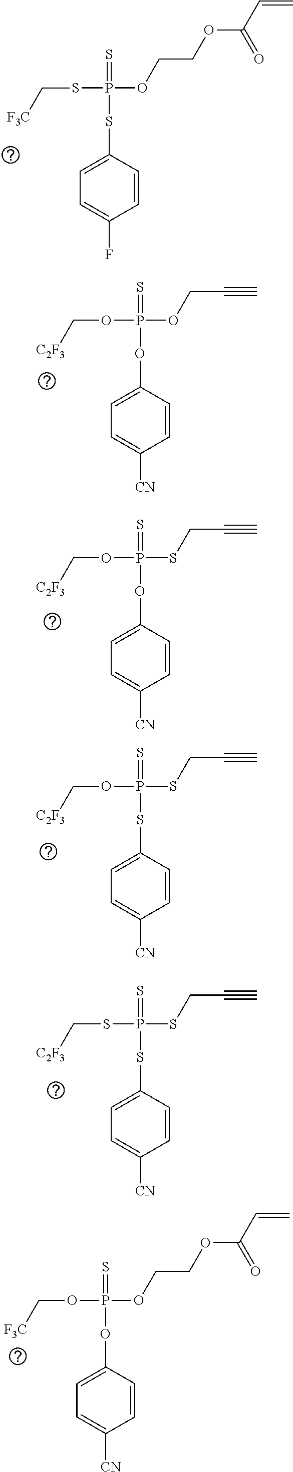

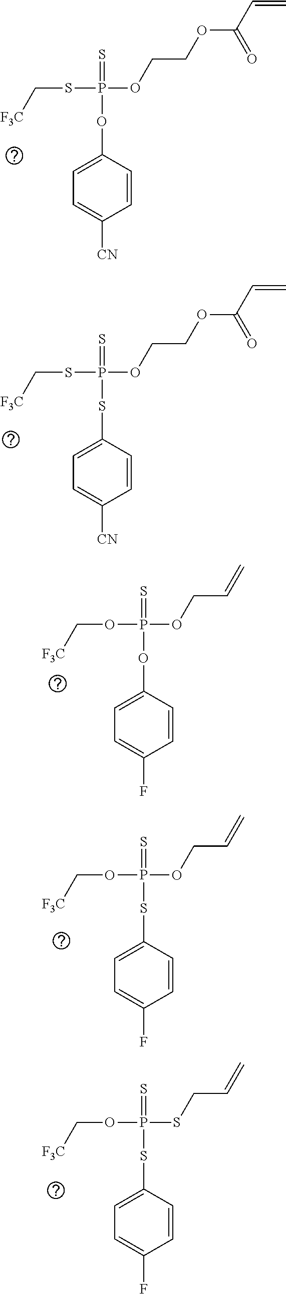 [SMILES: C=CC(=O)OCCOP(=S)(Oc1ccc(C#N)cc1)SCC(F)(F)F ; C=CC(=O)OCCOP(=S)(SCC(F)(F)F)Sc1ccc(C#N)cc1 ; C=CCOP(=S)(OCC(F)(F)F)Oc1ccc(F)cc1 ; C=CCOP(=S)(OCC(F)(F)F)Sc1ccc(F)cc1 ; C=CCSP(=S)(OCC(F)(F)F)Sc1ccc(F)cc1]

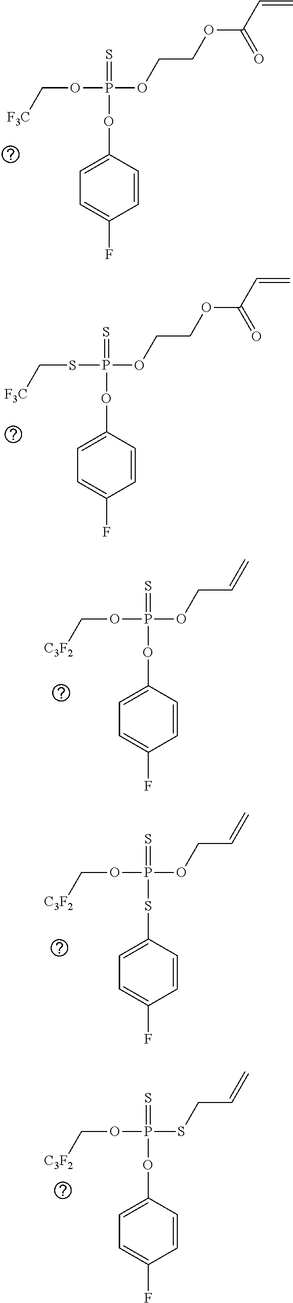

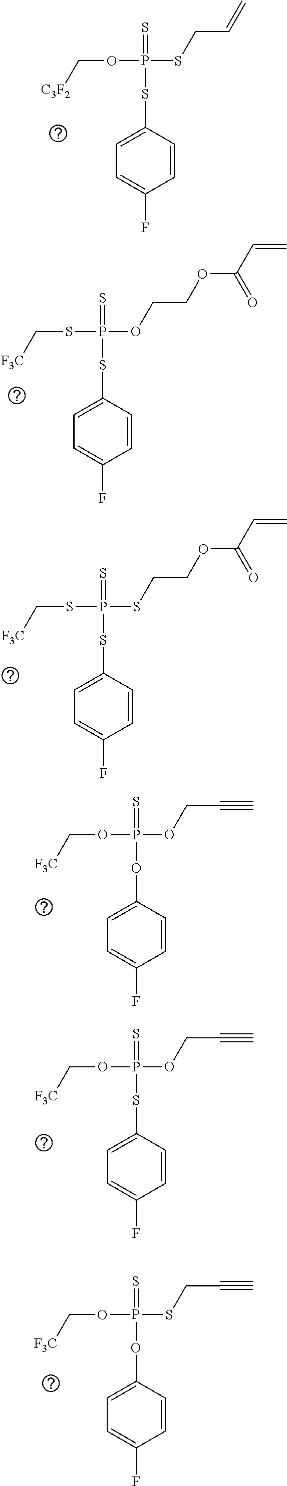

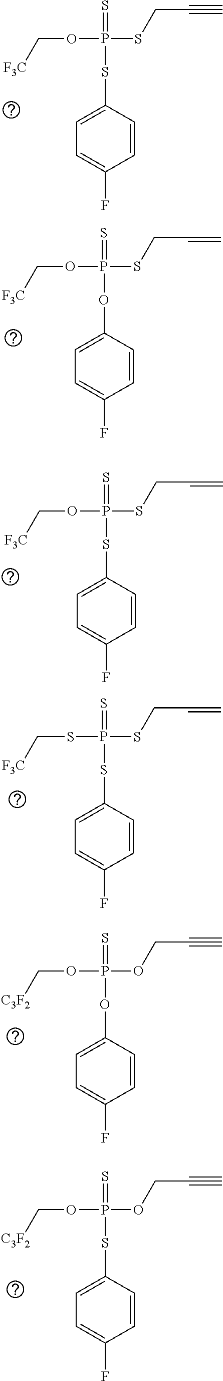

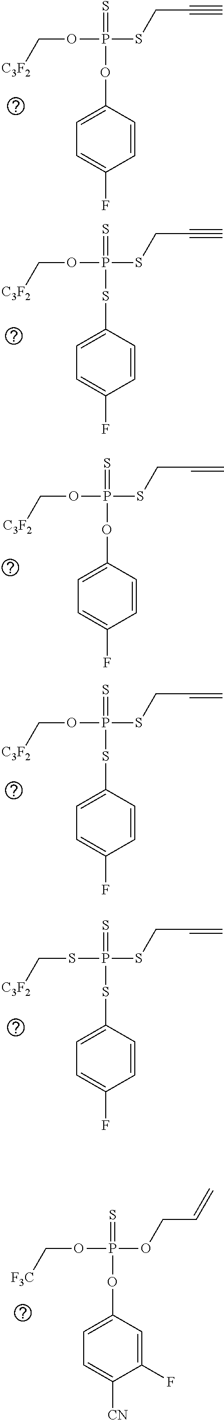

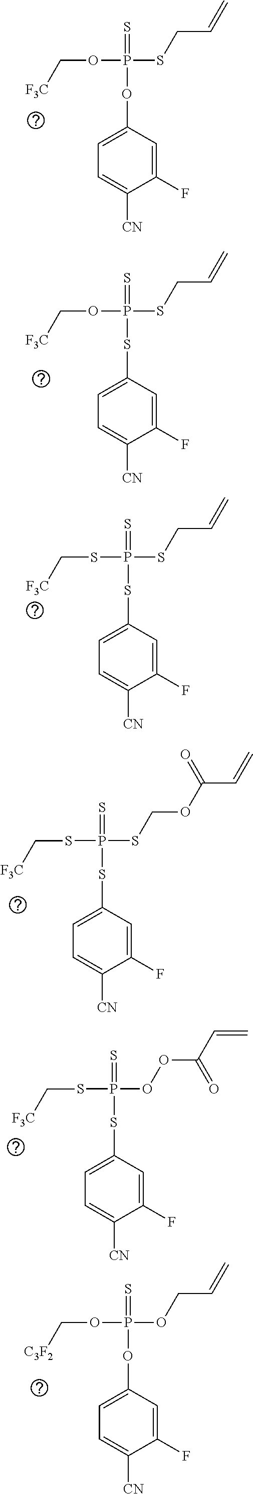

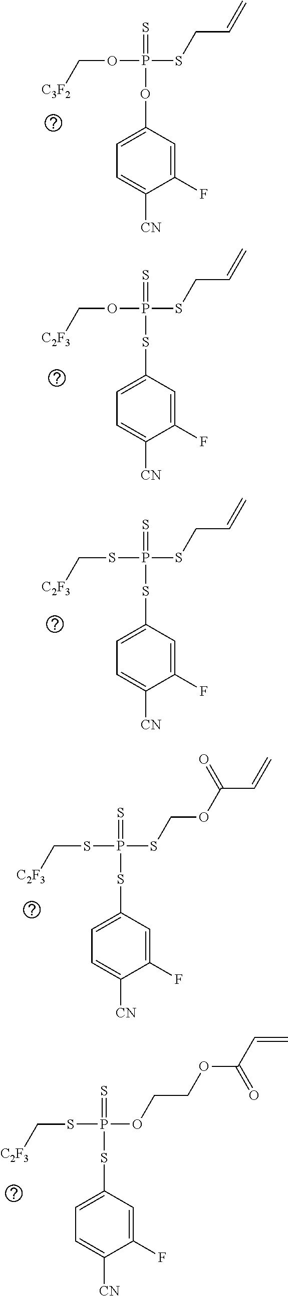

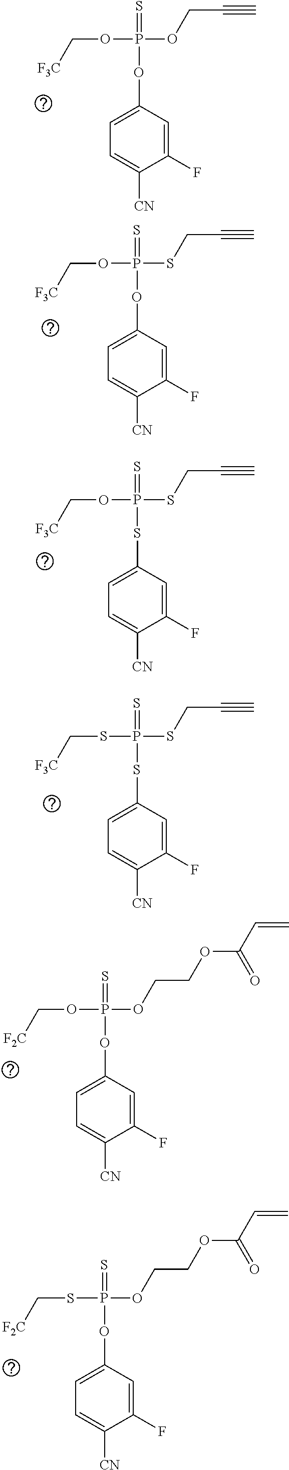

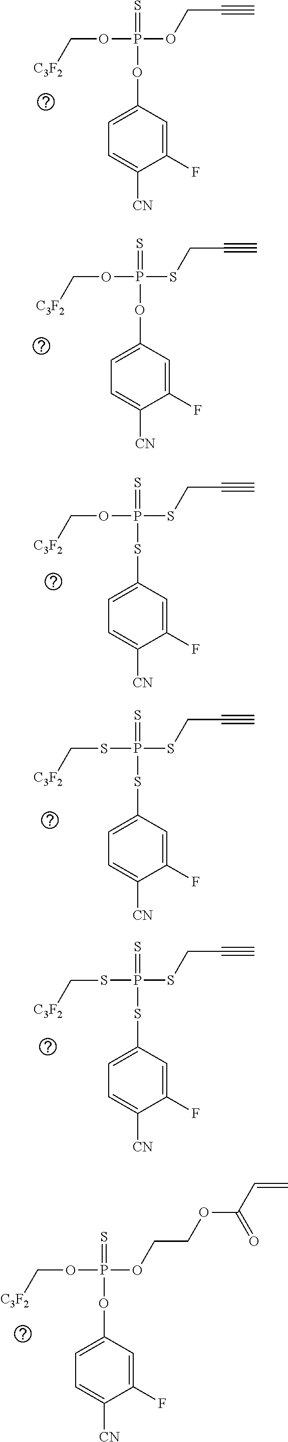

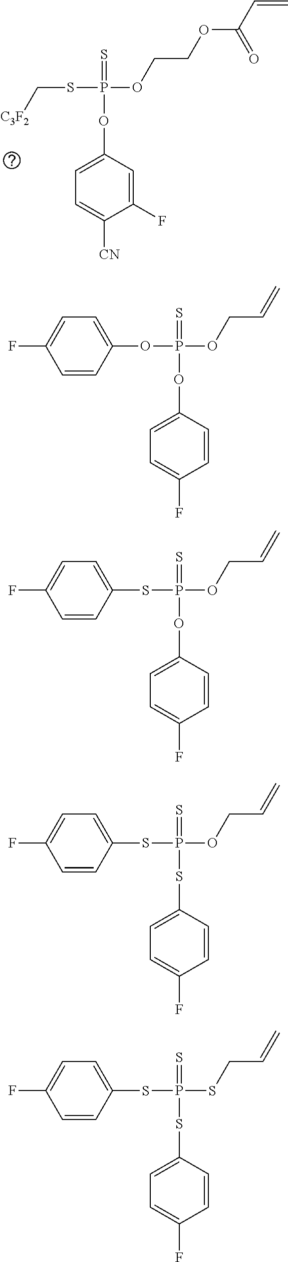

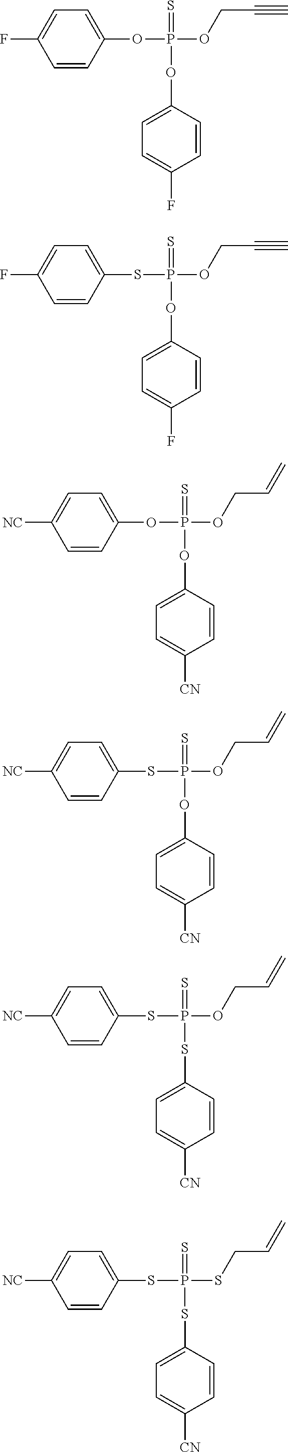

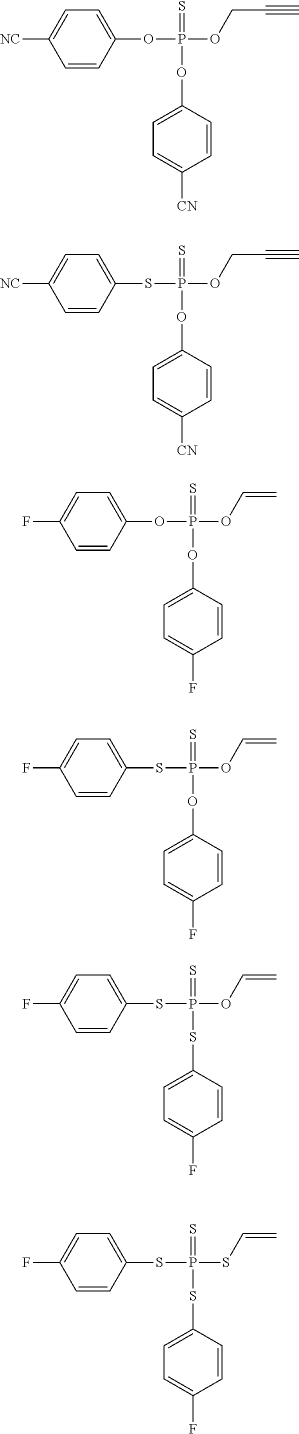

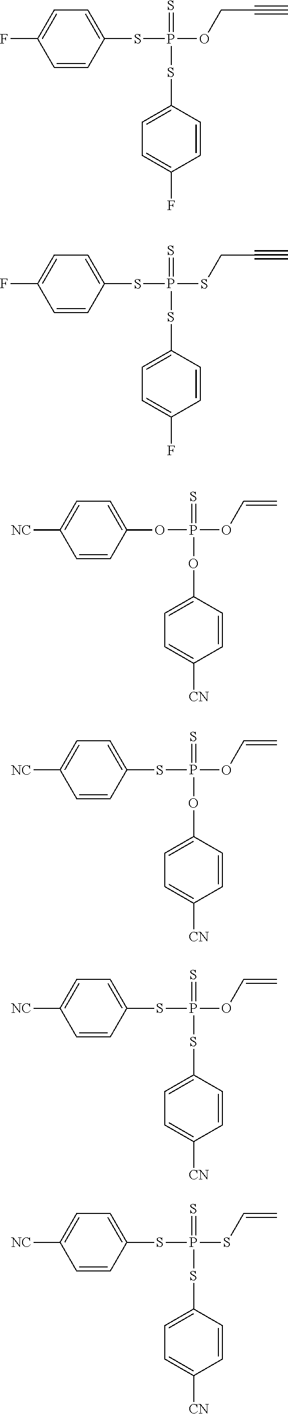

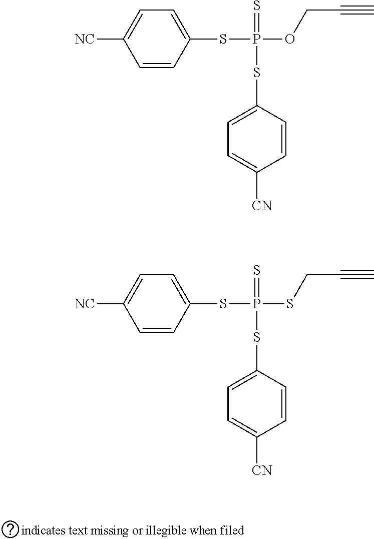 [SMILES: C#CCOP(=S)(Sc1ccc(C#N)cc1)Sc1ccc(C#N)cc1 ; C#CCSP(=S)(Sc1ccc(C#N)cc1)Sc1ccc(C#N)cc1]

Further, the disclosure will illustrate specific examples. These examples are only an illustration and are not meant to limit the disclosure or the claims to follow.

### Example A—Synthesis of Propargyl-diethylthiophosphate

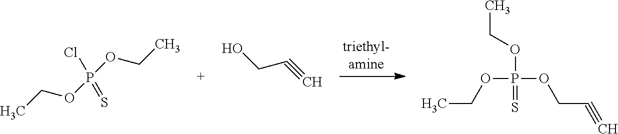

| Reagent | MW | Equiv | Mol | Mass (g) | Density | Volume (mL) | Conc | Yield (calc) |
|---|---|---|---|---|---|---|---|---|
| propargyl alcohol | 56.06 | 1.00 | 0.032 | 1.8 | 0.963 | 1.9 | | |
| diethylchlorothiophosphate | 188.61 | 1.00 | 0.032 | 6.1 | 1.200 | 5.0 | | |
| DCM | | | | 15.7 | 1.326 | 11.8 | 50% | |
| triethylamine | 101.19 | 1.00 | 0.032 | 3.2 | 0.726 | 4.5 | | |
| propargyl-diethylthiophosphate | 208.17 | 1.00 | | | | | | 6.7 |
| triethylamine-HCl | 137.65 | 1.00 | 0.032 | | | | | 4.4 |

To a 40 mL vial equipped with a magnetic stirring bar was added propargyl alcohol in dichloromethane (DCM) (15 mL). Triethylamine was added by pipet to the mixture and an exotherm to 31° C. was observed. While stirring at RT, diethylchlorothiophosphate was slowly added by pipet. No exotherm or gas evolution was observed. A white solid precipitate (triethylamine-HCl) slowly formed and the mixture stirred at RT for 24 h. DI water (2×10 mL) was added and the mixture was poured into a separatory funnel. The organic phase was extracted into DCM (10 mL), separated, dried over MgSO₄, filtered and the solvent stripped by rotary evaporation. The oil was passed through a 0.45 μm GMF filter. Yield: yellow oil, 6.2 g, (93%).

FTIR: 3292, 2983, 1008, 793, 652 cm⁻¹.

### Example B—Synthesis of Allyl-diethylthiophosphate

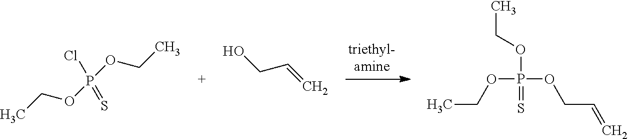

| Reagent | MW | Equiv | Mol | Mass (g) | Density | Volume (mL) | Conc | Yield (calc) |
|---|---|---|---|---|---|---|---|---|
| allyl alcohol | 58.08 | 1.00 | 0.033 | 1.9 | 0.854 | 2.2 | | |
| diethylchlorothiophosphate | 188.61 | 1.00 | 0.033 | 6.2 | 1.200 | 5.1 | | |
| DCM | | | | 16.1 | 1.326 | 12.2 | 50% | |
| triethylamine | 101.19 | 1.00 | 0.033 | 3.3 | 0.726 | 4.6 | | |
| allyl-diethylthiophosphate | 210.19 | 1.00 | | | | | | 6.9 |
| triethylamine-HCl | 137.65 | 1.00 | 0.033 | | | | | 4.5 |

To a 40 mL vial equipped with a magnetic stirring bar was added allyl alcohol in DCM (15 mL). Triethylamine was added by pipet and the mixture and an exotherm to 31° C. was observed. While stirring at RT, diethylchlorothiophosphate was slowly added by pipet. No exotherm or gas evolution was observed. A white solid precipitate (triethylamine-HCl) slowly formed and the mixture stirred at RT for 24 h. DI water (2×10 mL) was added and the mixture was poured into a separatory funnel. The organic phase was extracted into DCM (10 mL), separated, dried over MgSO₄, filtered and the solvent stripped by rotary evaporation. The oil was passed through a 0.45 μm GMF filter. Yield: pale yellow oil, 5.7 g, (83%).

FTIR: 2983, 1006, 794, 652 cm⁻¹.

### Example C—Synthesis of Tris(propargyl)-thiophosphate

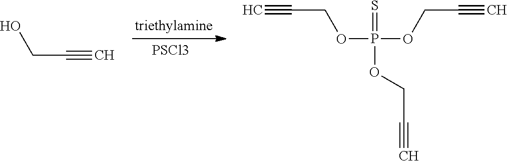

| Reagent | MW | Equiv | Mol | Mass (g) | Density | Volume (mL) | Conc | Yield (calc) |
|---|---|---|---|---|---|---|---|---|
| PSCl3 | 169.40 | 1.00 | 0.035 | 6.0 | 1.668 | 3.6 | | |
| propargyl alcohol | 56.06 | 3.00 | 0.106 | 6.0 | 0.963 | 6.2 | | |
| triethylamine | 101.19 | 3.00 | 0.106 | 10.8 | 0.723 | 14.9 | | |
| DCM | | | | 25.1 | 1.326 | 18.9 | 25% | |
| (propargyl)3-thiophosphate | 228.08 | 1.00 | 0.000 | | | | | 8.1 |
| triethylamine-HCl | 137.65 | 3.00 | | | | | | 14.6 |

To a 100 mL 3-neck flask equipped with a magnetic stirring bar, water-cooled condenser, N₂ inlet and thermocouple was added propargyl alcohol in DCM (20 mL). Triethylamine was added by pipet and an exotherm to 38° C. was observed. While stirring at RT, thiophosphorylchloride was slowly added by pipet. An exotherm to 46° C. was observed. A white solid ppt (triethylamine-HCl) slowly formed and the mixture stirred at RT for 4 h. DI water (2×20 mL) was added and the mixture was poured into a separatory funnel. The organic phase was extracted into DCM, separated, dried over MgSO₄ and the solvent stripped by rotary evaporation. A crystal of BHT was added to prevent polymerization. Yield: amber oil, 8.8 g, (>99%). The oil was pumped under high vacuum and a gelatinous ppt was formed. The oil was passed through a 0.45 μm GMF filter. Yield: dark viscous amber oil, 5.6 g, (69%).

FTIR: 1472, 1158, 1018, 643 cm⁻¹.

### Example D—Synthesis of Tris(allyl)-thiophosphate

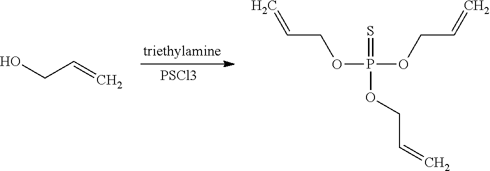

| Reagent | MW | Equiv | Mol | Mass (g) | Density | Volume (mL) | Conc | Yield (calc) |
|---|---|---|---|---|---|---|---|---|
| PSCl3 | 169.40 | 1.00 | 0.047 | 8.0 | 1.668 | 4.8 | | |
| allyl alcohol | 58.08 | 3.00 | 0.142 | 8.2 | 0.854 | 9.6 | | |
| triethylamine | 101.19 | 3.00 | 0.142 | 14.3 | 0.723 | 19.8 | | |
| DCM | | | | 34.3 | 1.326 | 25.9 | 25% | |
| (allyl)3-thiophosphate | 234.14 | 1.00 | 0.000 | | | | | 11.1 |
| triethylamine-HCl | 137.65 | 3.00 | | | | | | 19.5 |

To a 100 mL 3-neck flask equipped with a magnetic stirring bar, water-cooled condenser, N₂ inlet and thermocouple was added allyl alcohol in DCM (20 mL). Triethylamine was added by pipet and the mixture and an exotherm to 40° C. was observed. While stirring at RT, thiophosphorylchloride was slowly added by pipet. An exotherm to 46° C. was observed. A white solid ppt (triethylamine-HCl) slowly formed and the mixture stirred at RT for 24 h. DI water (2×10 mL) was added and the mixture was poured into a separatory funnel. The organic phase was extracted into DCM (10 mL), separated, dried over MgSO₄, filtered and the solvent stripped by rotary evaporation. Yield: yellow oil, 13.9 g, (>99%). The oil was pumped under high vacuum and a gelatinous ppt was formed. The oil was passed through a 0.45 μm GMF filter and a crystal of BHT was added to prevent further polymerization. Yield: yellow oil, 7.3 g, (66%).

FTIR: 2983, 1006, 794, 652 cm⁻¹.

### Example E—Synthesis of Tris(allylthio)-thiophosphate

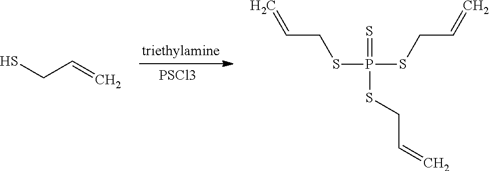

| Reagent | MW | Equiv | Mol | Mass (g) | Density | Volume (mL) | Conc | Yield (calc) |
|---|---|---|---|---|---|---|---|---|
| PSCl3 | 169.40 | 1.00 | 0.030 | 5.0 | 1.668 | 3.0 | | |
| allyl mercaptan | 74.14 | 3.00 | 0.089 | 6.6 | 0.900 | 7.3 | | |
| triethylamine | 101.19 | 3.00 | 0.089 | 9.0 | 0.723 | 12.4 | | |
| DCM | | | | 95.1 | 1.326 | 71.7 | 10% | |
| (allylthio)3-thiophosphate | 282.32 | 1.00 | 0.000 | | | | | 8.3 |
| triethylamine-HCl | 137.65 | 3.00 | | | | | | 12.2 |

To a 100 mL 3-neck flask equipped with a magnetic stirring bar, water-cooled condenser, N₂ inlet and thermocouple was added allyl mercaptan in DCM (70 mL). Triethylamine was added by pipet and an exotherm to 28° C. was observed. While stirring at RT, thiophosphorylchloride was slowly added by pipet to the colorless mixture. An exotherm to 42° C. was observed and a white solid ppt (triethylamine-HCl) quickly formed. The mixture stirred at RT for 3 h. DI water (2×30 mL) was added and the mixture was poured into a separatory funnel. The organic phase was extracted into DCM, separated, dried over MgSO4, filtered and the solvent stripped by rotary evaporation. Yield: yellow oil, 8.3 g, (>99%). The oil was pumped under high vacuum and a gelatinous ppt was formed. The oil was passed through a 0.45 μm GMF filter. Yield: yellow oil, 5.6 g (68%).

FTIR: 2983, 1006, 794, 652 cm⁻¹.

### Example F—Synthesis of Tris(ethylacrylate)thiophosphate

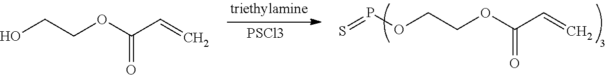

| Reagent | MW | Equiv | Mol | Mass (g) | Density | Volume (mL) | Conc | Yield (calc) |
|---|---|---|---|---|---|---|---|---|
| PSCl3 | 169.40 | 1.00 | 0.030 | 5.0 | 1.668 | 3.0 | | |
| 2-hydroxyethyl acrylate | 116.12 | 3.00 | 0.089 | 10.3 | 1.011 | 10.2 | | |
| triethylamine | 101.19 | 3.00 | 0.089 | 9.0 | 0.723 | 12.4 | | |
| DCM | | | | 77.6 | 1.326 | 58.6 | 15% | |
| (ethylacrylate)3-thiophosphate | 408.26 | 1.00 | 0.000 | | | | | 12.1 |
| triethylamine-HCl | 137.65 | 3.00 | | | | | | 12.2 |

To a 100 mL 3-neck flask equipped with a magnetic stirring bar, water-cooled condenser, N₂ inlet and thermocouple was added 2-hydroxyethyl acrylate in DCM (60 mL). Triethylamine was added by pipet and an exotherm to 27° C. was observed. While stirring at RT, thiophosphorylchloride was slowly added by syringe. An exotherm to 40° C. was observed and the colorless mixture turned pale yellow. A white solid ppt (triethylamine-HCl) slowly formed and the mixture stirred at RT for 3 h. DI water (2×20 mL) was added and the mixture was poured into a separatory funnel. The organic phase was extracted into DCM, separated, dried over MgSO₄, filtered and the solvent stripped by rotary evaporation. A crystal of BHT was added to prevent polymerization. The oil was pumped under high vacuum and a gelatinous ppt was formed. The oil was passed through a 0.45 μm GMF filter. Yield: gelled amber oil, 8.7 g, (72%).

FTIR: 1721, 1183, 969, 806, 656 cm⁻¹.

### Example G—Electrolytes for NMC811/Si—Gr Cells

Electrolyte formulations were prepared in a dry argon filled glovebox by combining all the electrolyte components in a glass vial and stirring for 24 hours to ensure complete dissolution of the salts. The thiophosphate ester additive with an unsaturated terminal group is added to a base electrolyte formulation comprising a 1:1:1 by volume mixture of ethylene carbonate, “EC”, ethyl methyl carbonate, “EMC”, and dimethyl carbonate, “DMC” and 1 M lithium hexafluorophosphate, “LiPF6”, as a Li⁺ ion conducting salt, dissolved therein. Embodiment Example 1 (EE1) uses a representative example molecule as per the present disclosure. The electrolyte components and additives used in are summarized in Table A.

TABLE A
Electrolyte Formulations for NMC811/Si-Gr cells

| Electrolyte | CE1 | EE1 |
|---|---|---|
| Base Formulation | 1.0M LiPF₆ | 1.0M LiPF₆ |
| | in EC/EMC/DEC | in EC/EMC/DEC |
| | (1/1/1 vol. %) | (1/1/1 vol. %) |
| Vinylene | 1% | 1% |
| Carbonate (VC) | | |
| Fluoroethylene | 1% | 1% |
| Carbonate (FEC) | | |
| 1,3 Propane | | 0.5% |
| Sultone (PaS) | | |
| Propargyl- | | 0.5% |
| Diethylthiophosphate | | |

### Example H—NMC811/Si—Gr Cells

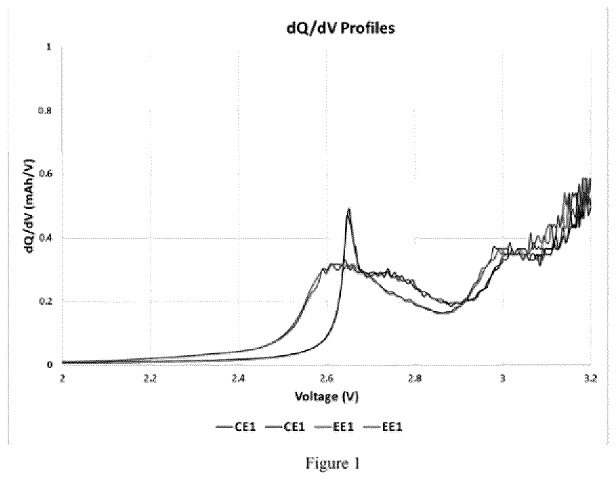

The electrolyte formulations prepared are used as electrolytes in 1.3 Ah Li-ion pouch cells including NMC811 cathode active material and silicon-graphite (7% Si) as the anode active material. The cell operation voltage window is 4.2-2.7 V. In each cell, 3.75 g of electrolyte was added and allowed to soak in the cell for 1 hour. The cells were vacuum sealed, and primary charged and then allowed to rest at room temperature for 10 hours. The cells were then charged to 3.8 V at C/25 rate before degassing, followed by vacuum sealing. After degassing, the cells were charged and discharged twice between 4.2 to 2.7 V at C/10 rate, and the results are summarized in Table B. The Initial Capacity Loss (iCL) is calculated based on the first cycle Coulombic Efficiency, and the reported formation discharge capacity is for the last cycle of formation. AC-IR is the measured internal resistance at 1kHz frequency. Cells with electrolyte EE1 have a significantly lower iCL value, indicating higher reversible capacity during formation. This is also aligned with the dQ/dV profiles in FIG. 1 showing EE1 having an earlier reaction on the anode compared to CE1. This is a result of unique reaction of additives present in EE1, resulting in formation of a robust SEI, leading to higher reversible capacity.

TABLE B
Initial Cell Data for NMC811/Si-Gr cells

| | Initial | | |
|---|---|---|---|
| | Capacity | Formation Discharge | AC-IR |
| Electrolyte | Loss (%) | Capacity (Ah) | (mΩ) |
| CE1 | 29.2 | 1.19 | 14.91 |
| EE1 | 23.1 | 1.18 | 15.51 |

### Example I—Electrolytes for NMC811/Gr Cells

The thiophosphate ester additive with an unsaturated terminal group is added to a base electrolyte formulation including a 3:7 by weight mixture of ethylene carbonate, “EC” and ethyl methyl carbonate, “EMC”, and 1 M lithium hexafluorophosphate, “LiPF6”, as a Li⁺ ion conducting salt, dissolved therein. Comparative Example 2 (CE2) is composed of the base formulation and vinylene carbonate and 1,3 propane sultone as the additives, and Embodiment Examples 2 and 3 (EE2 and EE3) uses a representative example molecule as per the present disclosure. The electrolyte components and additives used in are summarized in Table C.

TABLE C
Electrolyte Formulations for NMC811/Gr cells

| Electrolyte | CE2 | CE3 | EE2 | EE3 |
|---|---|---|---|---|
| Base Formulation | 1.0M LiPF₆ | 1.0M LiPF₆ | 1.0M LiPF₆ | 1.0M LiPF₆ |
| | in EC/EMC | in EC/EMC | in EC/EMC | in EC/EMC |
| | (3/7 wt. %) | (3/7 wt. %) | (3/7 wt. %) | (3/7 wt. %) |
| Vinylene | 2% | 2% | 2% | 2% |
| Carbonate (VC) | | | | |
| 1,3 Propane | | 0.5% | | |
| Sultone (PaS) | | | | |
| Allyl- | | | 0.5% | |
| Diethylthiophosphate | | | | |
| Propargyl- | | | | 0.5% |
| Diethylthiophosphate | | | | |

### Example J—NMC811/Gr Cells

The electrolyte formulations prepared are used as electrolytes in 1.8 Ah Li-ion pouch cells including NMC811 cathode active material and graphite as the anode active material. The cell operation voltage window is 4.2-2.8 V. In each cell, 6 g of electrolyte was added and allowed to soak in the cell for 1 hour. The cells were vacuum sealed and allowed to rest at room temperature for 24 hours. The cells were then charged to 3.7 V at C/25 rate before degassing, followed by vacuum sealing. After degassing, the cells were charged and discharged twice between 4.2 to 2.8 V at C/10 rate, and the results are summarized in Table D. The iCL, formation discharge capacity and AC-IR measurements were conducted similar to Example G.

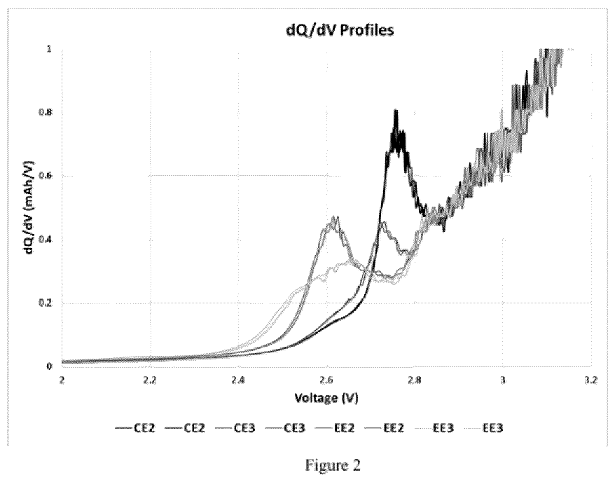

FIG. 2 shows the dQ/dV profiles of cells with different electrolytes, and the effect of allyl and propargyl thiophosphate molecules on the SEI reaction is evident. Both molecules react at ˜2.6 V, while the electrolytes with VC and PaS react around 2.75 V.

TABLE D
Initial Cell Data for NMC811/Gr cells

| | Initial | | |
|---|---|---|---|
| | Capacity | Formation Discharge | AC-IR |
| Electrolyte | Loss (%) | Capacity (Ah) | (mΩ) |
| CE2 | 15.1 | 1.77 | 13.15 |
| CE3 | 14.4 | 1.77 | 13.40 |
| EE2 | 15.3 | 1.76 | 13.22 |
| EE3 | 15.2 | 1.77 | 13.47 |

### Example K—Electrolytes for NMC811/SCN Cells

The thiophosphate ester additive with an unsaturated terminal group is added to a base electrolyte formulation including a 3:7 by weight mixture of ethylene carbonate, “EC” and ethyl methyl carbonate, “EMC”, and 1 M lithium hexafluorophosphate, “LiPF6”, as a Li⁺ ion conducting salt, dissolved therein. Comparative Example 4 (CE4) is composed of the base formulation, and Comparative Example 5 (CE5) is composed of the base formulation with 5% fluoroethylene carbonate “FEC”. Embodiment Example 4 (EE4) uses a representative example molecule as per the present disclosure. The electrolyte components and additives used in are summarized in Table E.

TABLE E
Electrolyte Formulations for NMC811/SCN cells

| Electrolyte | CE4 | CE5 | EE4 |
|---|---|---|---|
| Base Formulation | 1.0M LiPF₆ | 1.0M LiPF₆ | 1.0M LiPF₆ |
| | in EC/EMC | in EC/EMC | in EC/EMC |
| | (3/7 wt. %) | (3/7 wt. %) | (3/7 wt. %) |
| Fluoroethylene | | 5% | |
| Carbonate (FEC) | | | |
| Propargyl- | | | 1.0% |
| Diethylthiophosphate | | | |

### Example L—NMC811/SCN Cells

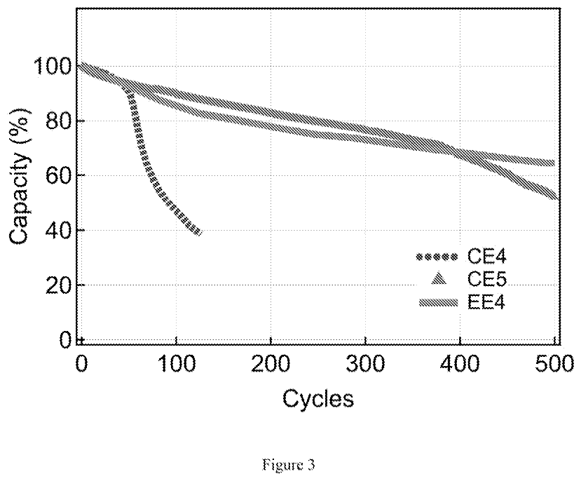

The electrolyte formulations prepared are used as electrolytes in 1.5 Ah Li-ion pouch cells including NMC811 cathode active material and silicon-carbon nanocomposite (SCN) as the anode active material. The cell operation voltage window is 4.2-2.8 V. In each cell, 6 g of electrolyte was added and allowed to soak in the cell for 1 hour. The cells were vacuum sealed and allowed to rest at room temperature for 24 hours. The cells were then charged to 3.7 V at C/25 rate before degassing, followed by vacuum sealing. After degassing, the cells were charged and discharged twice between 4.2 to 2.8 V at C/10 rate, and then charged and discharged five hundred times between 4.2 to 2.8 V at 1C rate at 25° C. FIG. 3 shows the cycle life characteristics of 1.5 Ah NMC811/SCN cells at 25° C. during cycling at 1 C rate for charging and discharging. Here, it is clear that addition of a thiophosphate ester additive with an unsaturated terminal group greatly improves the cyclability of NMC811/SCN cells relative to the comparative examples. The capacity retention after 500 cycles is higher for cells with EE4 compared to CE4 and CES. This data is summarized in Table F.

TABLE F
Data after 500 Cycles in NMC811/SCN cells

| | Initial | Retention (%) | Retention (%) |
|---|---|---|---|
| Electrolyte | Capacity (Ah) | at 100 cycles | at 500 cycles |
| CE4 | 1.55 | 47.1 | 0.0 |
| CE5 | 1.51 | 89.8 | 52.1 |
| EE4 | 1.51 | 85.5 | 64.5 |

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed is:

1. An electrochemical energy storage device electrolyte comprising:
a) an aprotic organic solvent system;
b) a metal salt; and
c) at least one thiophosphate additive having an unsaturated terminal group, according to the formula: 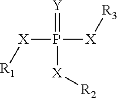
wherein:
Y is oxygen or sulfur;
X is independently oxygen or sulfur, with the proviso that if Y is oxygen then least one X is sulfur;
R₃ is selected from hydrocarbyl group having 1 to 10 carbon atoms with an unsaturated terminal group;
R₁ and R₂ is R₃; or
R₁ and R₂ are independently C₁-C₁₀ substituted or unsubstituted alkyl groups, or aryl groups;
wherein the hydrogen atoms can be unsubstituted or can be a halogen, alkyl, alkoxy, perfluorinated alkyl, silyl, siloxy, silane, sulfoxide, amide, azo, ether, and thioether group or combinations thereof.

2. The electrolyte of claim 1, wherein the unsaturated terminal group can be selected from a group consisting of alkenyl and alkynyl groups such as allyl, propargyl, and vinyl groups; styrenic, and acrylic groups, or combinations thereof.

3. The electrolyte of claim 1, wherein the thiophosphate additive with an unsaturated terminal group is present in a concentration of from 0.001 wt. % to 25 wt. % in the electrolyte.

4. The electrolyte of claim 1, wherein the aprotic organic solvent system comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixtures thereof.

5. The electrolyte of claim 1, wherein the aprotic organic solvent system is present in a concentration of from 60 wt. % to 90 wt. % in the electrolyte.

6. The electrolyte of claim 1, wherein the cation of the metal salt is an alkali metal.

7. The electrolyte of claim 6, wherein the alkali metal is lithium or sodium.

8. The electrolyte of claim 1, wherein the cation of the metal salt is aluminum or magnesium.

9. The electrolyte of claim 1, wherein the metal salt is present in a concentration of from 10 wt. % to 30 wt. % in the electrolyte.

10. The electrolyte of claim 1, further comprising at least one additional additive.

11. The electrolyte of claim 10, wherein the at least one additional additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof.

12. The electrolyte of claim 10, wherein the at least one additional additive comprises a partially or fully halogenated phosphoric acid ester compound, an ionic liquid, or mixtures thereof

13. The electrolyte of claim 12, wherein the halogenated phosphoric acid ester compound is selected from the group consisting of 4-fluorophenyldiphenylphosphate, 3,5-difluorophenyldiphenylphosphate, 4-chlorophenyldiphenylphosphate, trifluorophenylphoshate, heptafluorobutyldiphenylphosphate, trifluoroethyldiphenylphosphate, bis(trifluoroethyl)phenylphosphate, and phenylbis(trifluoroethyl)phosphate.

14. The electrolyte of claim 12, wherein the ionic liquid is selected from the group consisting of tris(N-ethyl-N-methylpyrrolidinium)thiophosphate bis(trifluoromethylsulfonyl)imide, tris(N-ethyl-N-methylpyrrolidinium) phosphate bis(trifluoromethylsulfonyl)imide, tris(N-ethyl-N-methylpiperidinium)thiophosphate bis(trifluoromethylsulfonyl)imide, and tris(N-ethyl-N-methylpiperidinium)phosphate bis(trifluoromethylsulfonyl)imide.

15. The electrolyte of claim 10, wherein the at least one additional additive is present in a concentration of from 0.01 wt. % to 10 wt. % in the electrolyte.

16. An electrochemical energy storage device comprising:
a cathode;
an anode;
an electrolyte according to claim 1; and
a separator.

17. The device of claim 16, wherein the cathode comprises a lithium metal oxide, spinel, olivine, carbon-coated olivine, vanadium oxide, lithium peroxide, sulfur, polysulfide, a lithium carbon monofluoride or mixtures of any two or more thereof.

18. The device of claim 17, wherein the lithium metal oxide is, LiCoO₂, LiNiO₂, LiNiₓCo_{y}Met_{z}O₂, LiMn_{0.5}Ni_{0.5}O₂, LiMn_{0.1}Co_{0.1}Ni_{0.8}O₂, LiMn_{0.2}Co_{0.2}Ni_{0.6}O₂, LiMn_{0.3}Co_{0.2}Ni_{0.5}O₂, LiMn_{0.33}Co_{0.33}Ni_{0.33}O₂, LiMn₂O₄, LiFeO₂, Li_{1+x′}Ni_{α}Mn_{β}CO_{y}Met′₆₇ O_{2-z′}F_{z′}, A_{n′}B₂(XO₄)₃ (NASICON), vanadium oxide, lithium peroxide, sulfur, polysulfide, a lithium carbon monofluoride or mixtures of any two or more thereof, where Met is Al, Mg, Ti, B, Ga, Si, Mn or Co; Met′ is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤h′≤3.

19. The device of claim 16, wherein the anode comprises lithium metal, graphitic material, amorphous carbon, Li₄Ti₅O₁₂, tin alloy, silicon, silicon alloy, intermetallic compound, or mixtures thereof.

20. The device of claim 16, wherein the device comprises a lithium battery, lithium-ion battery, lithium-sulfur battery, lithium-air battery, sodium ion battery, magnesium battery, lithium/MnO₂ battery, or Li/poly(carbon monofluoride) battery.

21. The device of claim 16, wherein the device comprises a capacitor or solar cell.

22. The device of claim 16, wherein the device comprises an electrochemical cell.

23. The device of claim 16, further comprising a porous separator separating the anode and cathode from each other.

24. The device of claim 23, wherein the porous separator comprises an electron beam-treated micro-porous polyolefin separator or a microporous polymer film comprising nylon, cellulose, nitrocellulose, polysulfone, polyacrylonitrile, polyvinylidene fluoride, polypropylene, polyethylene, polybutene, or co-polymers or blends of any two or more such polymers. The device of claim 16, wherein the aprotic organic solvent system comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixtures thereof.

26. The device of claim 16, wherein the aprotic organic solvent system is present in a concentration of from 60 wt. % to 90 wt. % in the electrolyte.

27. The device of claim 16, wherein the cation of the metal salt is an alkali metal.

28. The device of claim 27, wherein the alkali metal is lithium or sodium.

29. The device of claim 16, wherein the cation of the metal salt is aluminum or magnesium.

30. The device of claim 28, wherein the alkali metal salt is present in a concentration of from 10 wt. % to 30 wt. % in the electrolyte.

31. The device of claim 13, the electrolyte further comprising at least one additional additive.

32. The device of claim 31, wherein the at least one additional additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof.

33. The device of claim 31, wherein the at least one additional additive comprises a partially or fully halogenated phosphoric acid ester compound, an ionic liquid, or mixtures thereof

34. The device of claim 33, wherein the halogenated phosphoric acid ester compound is selected from the group consisting of 4-fluorophenyldiphenylphosphate, 3,5-difluorophenyldiphenylphosphate, 4-chlorophenyldiphenylphosphate, trifluorophenylphoshate, heptafluorobutyldiphenylphosphate, trifluoroethyldiphenylphosphate, bis(trifluoroethyl)phenylphosphate, and phenylbis(trifluoroethyl)phosphate. The electrolyte of claim 33, wherein the ionic liquid is selected from the group consisting of tris(N-ethyl-N-methylpyrrolidinium)thiophosphate bis(trifluoromethylsulfonyl)imide, tris(N-ethyl-N-methylpyrrolidinium) phosphate bis(trifluoromethylsulfonyl)imide, tris(N-ethyl-N-methylpiperidinium)thiophosphate bis(trifluoromethylsulfonyl)imide, tris(N-ethyl-N-methylpiperidinium)phosphate bis(trifluoromethylsulfonyl)imide, N-methyl-trimethyl silylpyrrolidinium bis(trifluoromethylsulfonyl)imide, and N-methyl-trimethyl silylpyrrolidinium hexafluorophosphate.

36. The device of claim 31, wherein the at least one additional additive is present in a concentration of from 0.01 wt. % to 10 wt. % in the electrolyte.
